(19) United States
(12) Patent Application Publication
(10) Pub. No.: US 2023/0395342 A1
(43) Pub. Date: Dec. 7, 2023

(54) SMD TYPE TCO DEVICE

(71) Applicant: Dongguan Littelfuse Electronics Company Limited, Dongguan City (CN)

(72) Inventors: Werner Johler, Lenzburg (CH); Cheng HU, Dongguan City (CN); Jianming BU, Dongguan City (CN); Kevin Liang, Dongguan City (CN)

(73) Assignee: Dongguan Littelfuse Electronics Company Limited, Dongguan City (CN)

(21) Appl. No.: 18/033,133

(22) PCT Filed: Nov. 6, 2020
(86) PCT No.: PCT/CN2020/127258

§ 371 Date: Apr. 21, 2023

(51) Int. Cl. H01H 37/04

(52) U.S. Cl. CPC H01H 37/04; H01H 37/52; H01H 2037/046

(57) ABSTRACT

Thermal Cut-Off (TCO) devices suitable for surface mount reflow processes are disclosed. The TCO devices are modeled after existing lead attached TCO device structures, but are improved with compact and miniaturized structures suitable for surface mount reflow operations. The arm and base terminals include pads for surface mount reflow. The base molds are designed for receiving the PTC device, bimetal device, and arm terminal feature and may operate using either a single base terminal or a multi-part base terminal. Multiple cover designs are disclosed to lower the heat capacity of the upper plate of the TCO device relative to the base terminal. A TCO device featuring an integrated arm and bimetal device terminal is also disclosed, with an updated base portion to support the integrated terminal.

### FIELD OF THE DISCLOSURE

Embodiments of the present disclosure relate to thermal cut-off (TCO) devices, and, more particularly, to a TCO device suitable for surface mount reflow processes.

### BACKGROUND

Commonly, electrical devices include components that are designed to protect against certain fault conditions, such as an overcurrent condition, overvoltage condition, or excessive temperature. Thermal Cut-Off (TCO) devices, for example, respond to overtemperature conditions that may damage circuitry within the electronic device. TCOs may feature bimetal components and positive temperature coefficient (PTC) devices, for example.

Bimetal components consist of two metallic components having different thermal expansion coefficients that bend when subjected to a change in temperature. When included in an electrical device, the bimetal component activates when the electrical device reaches an abnormal, excessive temperature, such as due to excessive current. The bending of the bimetal component acts as a switch to interrupt the current flow through the electrical device. Once the temperature drops below the excessive temperature, the bimetal component returns to its original shape, allowing current to again flow through the electrical device.

Bimetal components have low resistance at the point of contact, good current carrying capability, and rapid response to changes in temperature. Bimetal components are sometimes combined with PTC components, where the PTC component acts as a heater to improve latching of the bimetal component. The bimetal component is disposed in series with the circuit of the electronic device being protected, while the PTC component is disposed in parallel to the bimetal component. When the bimetal component is activated, the current flowing through it is diverted to the PTC component, causing the PTC component to heat up, where this heat is transmitted to the bimetal component, causing the bimetal component to remain activated.

Existing TCO devices include the Metal Hybrid Protection (MHP) devices manufactured by Littelfuse®. The MHP devices include MHP-TA (thermal activation) devices, such as the MHP-TAM, which provides battery cell protection for high-capacity Lithium Polymer and prismatic cells used in notebook PCs, ultra-book, tablets, and smart phones, MHP-TAT, which are additionally used in gaming PCs, and MHP-TAC devices, which are additionally used in E-cigarette and battery-powered portable devices, due to their relatively smaller size.

These devices are currently used for lead attached applications to provide overcurrent and overtemperature protection for the attached electrical device. However, they are not designed for surface mount applications.

It is with respect to these and other considerations that the present improvements may be useful.

### SUMMARY

This Summary is provided to introduce a selection of concepts in a simplified form that are further described below in the Detailed Description. This Summary is not intended to identify key or essential features of the claimed subject matter, nor is it intended as an aid in determining the scope of the claimed subject matter.

An exemplary embodiment of a thermal cut-off (TCO) device in accordance with the present disclosure may include a base portion having a base mold and a base terminal. The base terminal includes first and second pads. The TCO device also includes a bimetal disc and an arm terminal to electrically connect to the base terminal. The first and second pads of the TCO device are attachable to a substrate using a surface mount reflow process.

Another exemplary embodiment of a TCO device in accordance with the present disclosure may include a cover plate, an integrated terminal, and a base portion. The base portion includes a base mold and a base terminal. The base terminal includes pads suitable for a surface mount reflow process.

### BRIEF DESCRIPTION OF THE DRAWINGS

FIG. 1 is a diagram illustrating a TCO device, in accordance with exemplary embodiments;

FIG. 2 is a diagram illustrating a base portion of the TCO device of FIG. 1, in accordance with exemplary embodiments;

FIG. 3 is a diagram illustrating the pads of the TCO device of FIG. 1, in accordance with exemplary embodiments;

FIG. 4 is a diagram illustrating a TCO device, in accordance with exemplary embodiments;

FIG. 5 is a diagram illustrating a base portion of the TCO device of FIG. 4, in accordance with exemplary embodiments;

FIG. 6 is a diagram illustrating a cover mold of the TCO device of FIG. 4, in accordance with exemplary embodiments;

FIG. 7 is a diagram illustrating a TCO device, in accordance with exemplary embodiments;

FIG. 8 is a diagram illustrating a TCO device, in accordance with exemplary embodiments;

FIG. 9 is a diagram illustrating a cover mold of the TCO device of FIG. 8, in accordance with exemplary embodiments;

FIG. 10 is a diagram illustrating a base portion of the TCO device of FIG. 8, in accordance with exemplary embodiments;

FIG. 11 is a diagram illustrating a cross-sectional view of the TCO device of FIG. 8, in accordance with exemplary embodiments; and

FIG. 12 is a diagram illustrating a TCO device, in accordance with exemplary embodiments.

### DETAILED DESCRIPTION

Thermal cut-off (TCO) devices suitable for surface mount reflow processes are disclosed. The TCO devices are modeled after existing lead attached TCO device structures, but are improved with compact and miniaturized structures suitable for surface mount reflow operations. The arm and base terminals include pads for surface mount reflow. The base molds are designed for receiving the PTC device, bimetal device, and arm terminal feature and may operate using either a single base terminal or a multi-part base terminal. Multiple cover designs are disclosed to lower the heat capacity of the upper plate of the TCO device relative to the base terminal. A TCO device featuring an integrated arm and bimetal device terminal is also disclosed, with an updated base portion to support the integrated terminal.

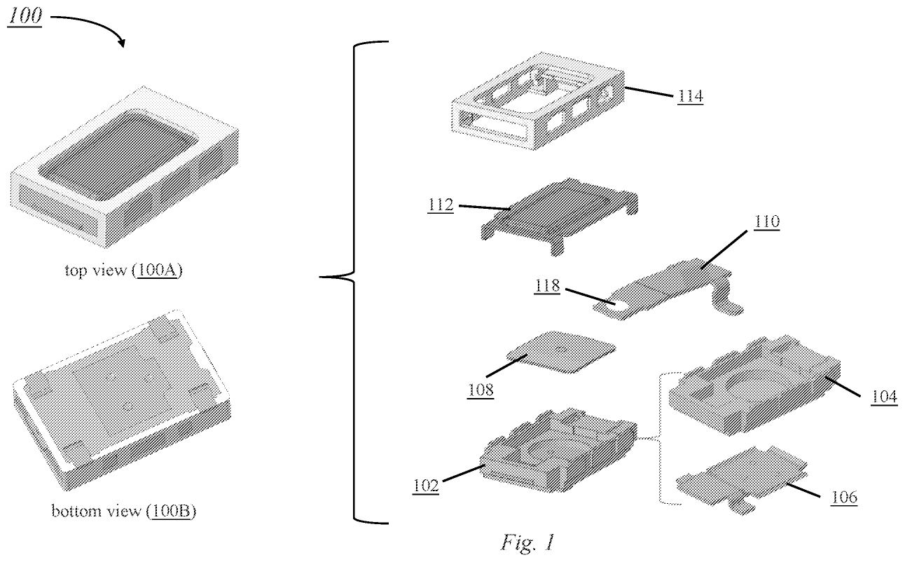

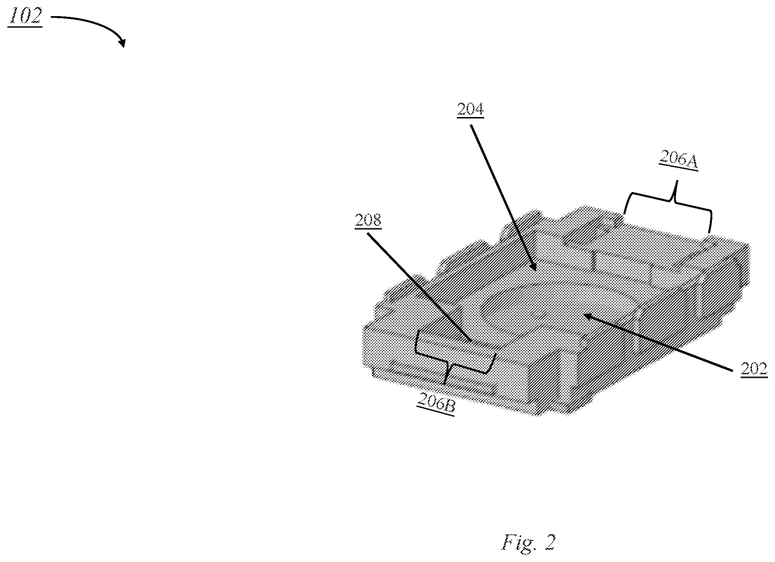

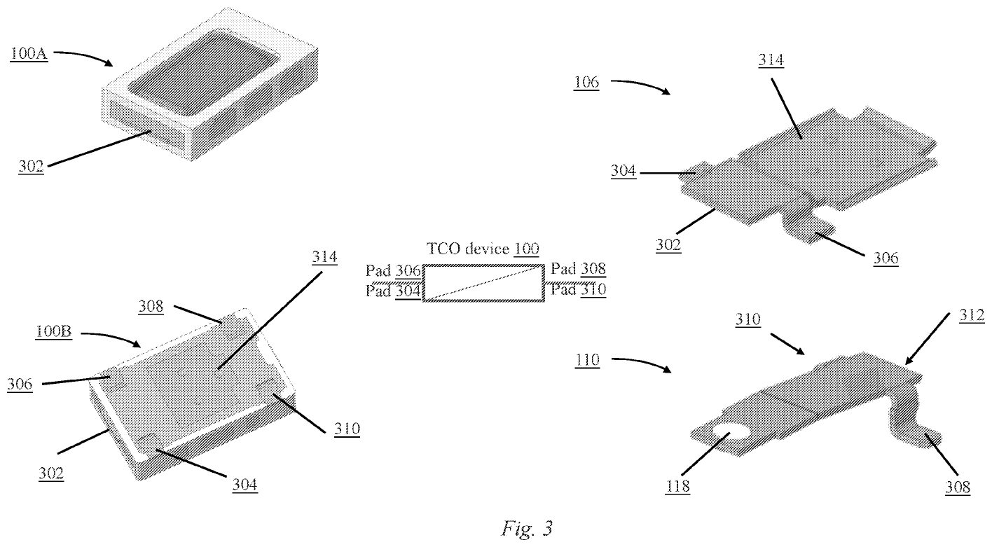

FIG. 1 is a representative exploded perspective drawing of a TCO device 100 usable as a Surface Mount Device (SMD) technology, according to exemplary embodiments. The TCO device 100, in which both a top view 100A and bottom view 100B are shown, includes a base portion 102 made up of a base mold 104 and a base terminal 106, a bimetal disc 108, an arm terminal 110, a cover 112, and a second mold 114. Optionally, the TCO device 100 additionally supports a PTC device (not shown). In an exemplary embodiment, the TCO device 100 is designed for a surface mount reflow application. FIGS. 2 and 3 provide further detail on some of the components of the TCO device 100.

The base portion 102 consists of the base mold 104 and the base terminal 106. In an exemplary embodiment, the base terminal 106 and the base mold 104 are molded together as one component, the base portion 102. The bimetal disc 108 is placed in the base portion, and the arm terminal 110 is then molded to the base mold 104. The cover 112 is placed over the assembly and then the second mold 114 encases the components, resulting in the TCO device 100 as shown. In an exemplary embodiment, both the base terminal 106 and the arm terminal 110 are made of copper. In exemplary embodiments, the cover 112, which is not part of the conduction path, is made of stainless steel or copper without isolated material covering, or made of stainless steel or copper with isolated material covering like epoxy coating or plastic molding material.

During normal operation, the TCO device 100 is connected in series to a device to be protected, such as a battery, or other circuitry. Current flows from the base terminal 106, which could be thought of as a first terminal, through the PTC device, if present, to the arm terminal 110, which could be thought of as a second terminal, and to the device being protected, and vice-versa. When an abnormal condition, such as an overtemperature condition, occurs, the bimetal disc 108, which is disposed between the base terminal 106 and the arm terminal 110 (or between the PTC device and the arm terminal) bends or deforms, such as in a convex position. This has the effect of causing the bimetal disc 108 to “lift” itself, such that the connection between the base terminal 106 and the arm terminal 110 is removed, disrupting flow of current to and thus protecting the device or circuitry to which the TCO device 100 is connected.

Existing TCO devices, such as MHP TCO devices of Littelfuse®, are designed for lead attached applications to provide overcurrent and overheating protection for a circuit, circuit components, or a device. By contrast, the exemplary TCO device 100 disclosed herein is particularly designed for surface mount reflow processes. In exemplary embodiments, the TCO device 100 takes the robust design concepts of the existing MHP TCO platforms and update them for compact and miniaturized applications, as well as surface mount reflow.

In contrast to the traditional soldering techniques used to attach components to printed circuit boards (PCBs), reflow soldering is a recent technique that enables mass production and speed by separating the placement of the components from the soldering process. In traditional soldering, the component is positioned on the PCB and soldered. This is followed by a second component being placed and soldered, and so on, until all the components of the PCB are soldered in place. With reflow soldering, the pads of the PCB, which are usually copper, are covered with soldering paste. With miniaturization, the pads may be very small and close together, relative to legacy PCBs. Therefore, a stencil is often used to ensure accurate application of the soldering paste to the pads. The components are then placed, one by one, onto the sticky soldering paste, where the stickiness of the soldering paste ensures that the components stay in place. Finally, the PCB is heated to a temperature that equals the melting temperature of the soldering paste, such as 265° C. Though there are different techniques for heating/melting the soldering paste, one common technique is to place the PCB in a specialized oven for this purpose. The melted soldering paste then “reflows” onto the terminals of the components that have been placed thereon, after which the PCB is allowed to cool. Thus, by using a surface mount reflow process, all components on the PCB are simultaneously assembled.

FIG. 2 is a representative perspective view of the base portion 102 of the TCO device 100 of FIG. 1, according to exemplary embodiments. The base portion 102 includes a receiving opening 202 for receiving an optional PTC device (not shown). At the bottom or floor of the receiving opening 202 is a visible portion of the base terminal 106. This enables an electrical connection to be established between the PTC device, if present, and the base terminal 106. One disadvantage of bimetal discs is that they are non-latching, mechanical contacts. By combining a PTC device and bimetal disc in parallel, the PTC device acts as a heater to provide latching, which keeps the bimetal disc bent, such as in a convex disposition, such that the TCO device remains tripped during the abnormal event. The TCO device 100 may operate with or without the PTC device.

In FIG. 2, the receiving opening 202 is shaped as an aperture or circular opening. The PTC device (not shown) is thus shaped as a cylindrical disc so as to fit snugly into the receiving opening 202. The PTC device would thus be in physical contact with the visible portion of the base terminal 106. However, the shape of the receiving opening 202 may be changed to accommodate differently-shaped PTC devices. For example, the receiving opening may be shaped as a rectangular cube, so as to receive a rectangular cube-shaped PTC device. Other shapes of the receiving opening 202 and associated PTC devices are also possible.

Further, the base portion 102 of FIG. 2 features a second receiving opening 204 that is disposed above the receiving opening 202. In an exemplary embodiment, the second receiving opening 204 is rectangular cube-shaped to receive the bimetal disc 108, which is also rectangular-cube shaped. Where a PTC device is present, the bimetal disc 108 will be adjacent to the PTC device. As with the receiving opening 202, the receiving opening 204 may be changed to accommodate differently shaped bimetal devices.

Further, the base portion 102 of FIG. 2 features a third receiving opening 206 that is disposed above the second receiving opening 204. This receiving opening 206 is shown in two parts, 206A on one side of the base portion 102, and 206B on the other side of the base portion. The receiving opening 206 is designed to seat the arm terminal 110. The base terminal 106 also includes a connecting portion 208. Returning to FIG. 1, the arm terminal 110 features a contact portion 118 for electrically coupling the arm terminal to the base terminal 106. When the arm terminal 110 is seated in the receiving opening 206 of the base portion 102, the contact portion 118 of the arm terminal rests on the connecting portion 208 of the base terminal 106, enabling a connection between the arm terminal and the base terminal.

FIG. 3 provides representative perspective views of the TCO device 100 of FIG. 1, according to exemplary embodiments. Again, the top view 100A and bottom view 100B are shown, as well as the components, the base terminal 106 and the arm terminal 110. In addition to being terminals, the base terminal and the arm terminal include additional features that make up the pads of the TCO device 100. Visible in the bottom view 100B, the TCO device features pads 304, 306, 308, and 310. Two of the pads 304 and 306 are part of the base terminal 106, while the other two pads 308 and 310 are part of the arm terminal 110 (though the pad 310 is obscured in the drawing).

An edge portion 302 of the base terminal 106 is also visible in both the top view 100A and the bottom view 100B of the TCO device. In an exemplary embodiment, the edge portion 302 is inserted through a rectangular opening of one side of the TCO device, such that the edge portion is sticking out and slightly visible. The contact portion 118 of the arm terminal 110 is also shown, for making contact with the connecting portion 208 of the base terminal 106 (FIG. 2). A center portion 314 of the base terminal 106 is also exposed in the bottom view 100B of the TCO device. The center portion 314 is exposed to the outside for positioning and fixing in the molding die, but does not make an electrical connection externally.

In a legacy TCO device, the terminals of the device establish a connection to external components of the circuit or device to be protected. In contrast to the legacy TCO devices, the TCO device 100 additionally includes pads on each terminal for connections to external components. The pads 304, 306, 308, and 310 thus enable the TCO device 100 to be suitable for surface mount reflow process applications.

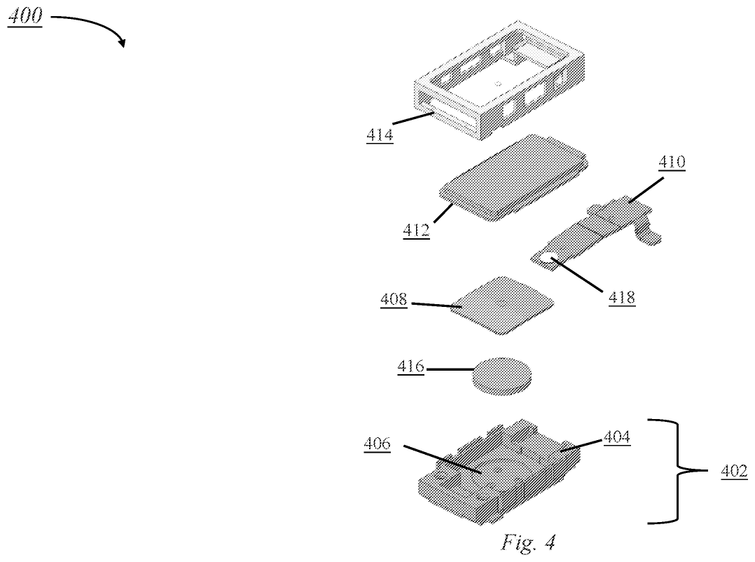

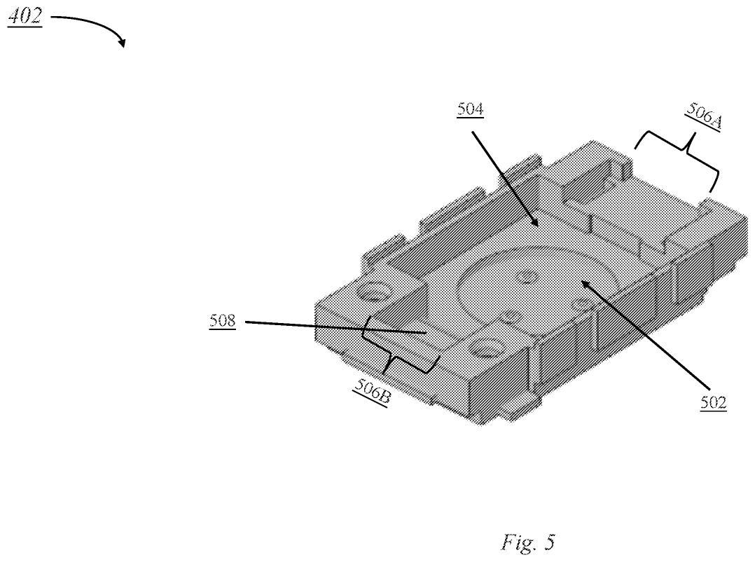

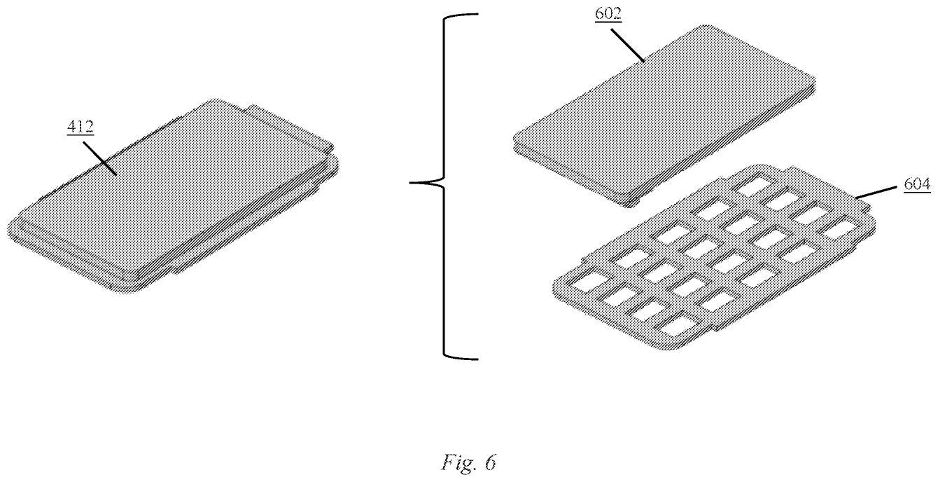

FIG. 4 is a representative exploded perspective drawing of a TCO device 400 usable as an SMD technology, according to exemplary embodiments. In addition to having a base portion 402 with a base mold 404 and base terminal 406, the TCO device 400 features a PTC device 416 that fits into the base portion. The TCO device 400 further includes a bimetal disc 408, an arm terminal 410, a cover mold 412, and a second mold 414. In an exemplary embodiment, both the base terminal 406 and the arm terminal 410 are made of copper. FIGS. 5 and 6 provide further detail on some of the components of the TCO device 400.

FIG. 5 is a representative perspective view of the base portion 402 of the TCO device 400 of FIG. 4, according to exemplary embodiments. The base portion 402 includes a receiving opening 502 for receiving the PTC device 416. At the bottom or floor of the receiving opening 402 is a visible portion of the base terminal 106. This enables an electrical connection to be established between the PTC device 416, if present, and the base terminal 406. As explained above, by combining a PTC device and bimetal disc in parallel, the PTC device acts as a heater to provide latching, which keeps the bimetal disc bent such that the TCO device remains tripped during the abnormal event. As with the TCO device 100 of FIG. 1, the TCO device 400 may operate with or without a PTC device.

Further, the receiving opening 502 may be shaped as a circular or other shaped opening, depending on the shape of the PTC device.

As with the base portion 102 (FIG. 2), the base portion 402 of the TCO device 400 features a receiving opening 502, for seating the PTC device (if present), a second receiving opening 504, disposed above the receiving opening 502, for seating the bimetal disc 408, and a third receiving opening 506 (shown in two parts 506A and 506B), for seating the arm terminal 406. These receiving openings 502, 504, and 506 may be shaped differently to accommodate differently shaped respective devices.

In an exemplary embodiment, the base portion 402 further includes a connecting portion 508. This connecting portion 508 is part of the base terminal 406, and is in a raised or higher plane than the portion visible in the receiving opening 502 and is also in a higher plane than the receiving opening 504. Returning to FIG. 4, the arm terminal 410 features a contact portion 418 for electrically coupling the arm terminal to the base terminal 406. When the arm terminal 410 is seated in the receiving opening 506 of the base portion 402, the contact portion 418 of the arm terminal rests on the connecting portion 506 of the base terminal 406, enabling a connection between the arm terminal and the base terminal. Thus, once the TCO device 400 is configured, the PTC device 416 and bimetal disc 408 are adjacent to one another and the bimetal disc 408 is covered with the arm terminal 410.

Returning to FIG. 4, the cover mold 412 of the exemplary TCO device 400 is different from the cover 112 of the TCO device 100. FIG. 6 is a represented perspective drawing of the cover mold 412 of the TCO device 400, according to exemplary embodiments. The cover mold 412 consists of a cover 602 and a cover plate 604. In an exemplary embodiment, the cover 602 is made of a plastic material, while the cover plate 604 is made of a slightly conductive material, such as SUS304, a type of stainless steel. SUS304 is known to be non-magnetic, easily formed into different shapes, and is resistant to rusting. In another embodiment, the cover plate 604 is made of brass.

Relative to copper, stainless steel is a poor conductor of electricity, while brass is about 28% as conductive as copper. Thus, in exemplary embodiments, these materials are selected for their strength, moldability, and resistance to rusting, not their conductive properties. In exemplary embodiments, relative to the cover mold 112 of the TCO device 100 (FIG. 1), the cover mold 412 of the TCO device 400 is designed to decrease the thickness of the cover. In one embodiment, the cover mold 412 is thinner than the cover 112. Further, holes are added to the cover plate 604 to decrease the volume of the cover mold 412.

Further, in an exemplary embodiment, the cover mold 412, and specifically, the cover plate 604, is chosen to have a lower heat capacity than that of the base terminal 406 of the base portion 402. Table 1 shows the heat capacity of four different exemplary cover plates 604, relative to that of the base terminal 406, which is made of copper. The material property, T, stands for thickness.

TABLE 1
Heat capacity for cover plate and base terminal of TCO device 400

| | | A | | | |
|---|---|---|---|---|---|
| | | specific heat | B | C | |
| | material | capacity | density | volume | heat capacity = |
| part | (mm) | (J/(kg K)) | (g/cm³) | (mm³) | A*B*C (10⁻⁶) |
| cover | SUS304 | 460 | 7.85 | 0.587 | 2119.7 |
| plate | (T = 0.08) | | | | |
| cover | SUS304 | 460 | 7.85 | 0.73375 | 2649.6 |
| plate | (T = 0.01) | | | | |
| cover | brass | 393 | 8.9 | 0.587 | 2053.1 |
| plate | (T = 0.08) | | | | |
| cover | brass | 393 | 8.9 | 0.73375 | 2566.4 |
| plate | (T = 0.01) | | | | |
| base | copper | 390 | 8.9 | 0.793 | 2752.5 |
| terminal | | | | | |

As Table 1 shows, the specific heat capacity parameter, A, for a given material does not change based on thickness. Thus, the SUS304 cover plate of 0.08 mm and the SUS304 cover plate of 0.01 mm both have a specific heat capacity of 460 J/(kg K) (Joules per kelvin per kilogram). Similarly, the density parameter, B, is unchanged with a change in thickness of materials. The volume parameter, C, is changed with a change in thickness. The heat capacity of the four versions of cover plate 412 given in Table 1 are all lower than the heat capacity of the base terminal 406. Thus, in an exemplary embodiment, for the TCO device 400:

Heat capacity of cover plate<heat capacity of base terminal (1)

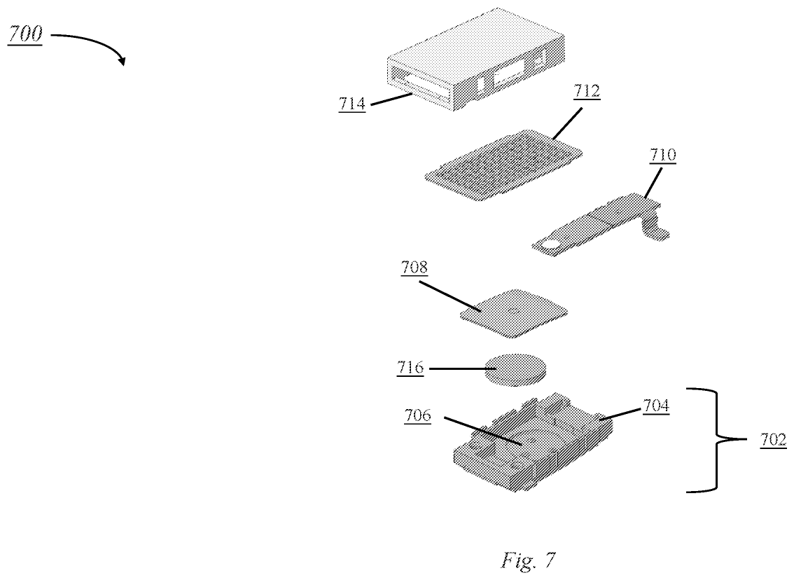

FIG. 7 is a representative exploded perspective drawing of a TCO device 700 usable as an SMD technology, according to exemplary embodiments. Similar to the TCO device 400 (FIG. 4), the TCO device 700 features a base portion 702 with a base mold 704 and base terminal 706, an optional PTC device 716 that fits into a receiving opening of the base portion 702, a bimetal disc 708, an arm terminal 710, and a second mold 714. A cover plate 712 of the TCO device 700 is different from respective covers of the TCO devices 100 and 400.

In an exemplary embodiment, the cover plate 712 has a special structure that makes it stronger. The cover plate 712 does not include a separate plastic cover, as in the TCO device 400. Instead, in some embodiments, the cover plate 712 is covered with bumps or dimples that are raised slightly from the surface of the cover plate. In an exemplary embodiment, the special structure of the cover plate 712 increases its strength, allows a thinner material to be used, and adds strength to the TCO device 700 that facilitates the surface mount reflow process, described above. The high-temperature reflow process will enable a bigger bimetal disc to be made, relative to prior art TCO devices. The bigger bimetal disc will deform to lift the arm terminal 710 with a higher force, in some embodiments. Thus, having a strong cover plate that is able to withstand the lifting force without any deformation from the arm terminal is preferred. A poorly designed cover plate will be unable to bear the force from the arm terminal, which will deform the TCO device and may cause structural issues, such as cracking of the molding material and loosening of the arm terminal with high resistance. In one embodiment, the SUS304 stainless steel material is used to make the cover plate 712.

Table 2 shows the heat capacity of the cover plate 712, relative to that of the base terminal 706, which is made of copper, according to exemplary embodiments. As before, the heat capacity of the cover plate 712 given in Table 2 is lower than the heat capacity of the base terminal 706. Thus, in an exemplary embodiment, the TCO device 700, like the TCO device 400, satisfies equation (1), above.

TABLE 2
Heat capacity for cover plate and base terminal of TCO device 700

| | | A | | | |
|---|---|---|---|---|---|
| | | specific heat | B | C | |
| | material | capacity | density | volume | heat capacity = |
| part | (mm) | (J/(kg K)) | (g/cm³) | (mm³) | A*B*C (10⁻⁶) |
| cover | SUS304 | 460 | 7.85 | 0.598 | 2159.4 |
| plate | (T = 0.05) | | | | |
| base | copper | 390 | 8.9 | 0.793 | 2752.5 |
| terminal | | | | | |

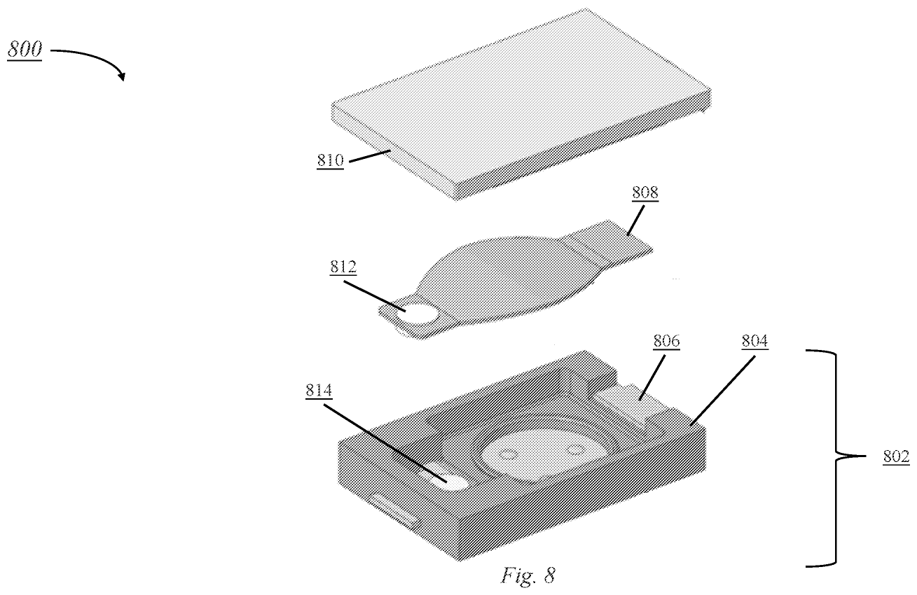

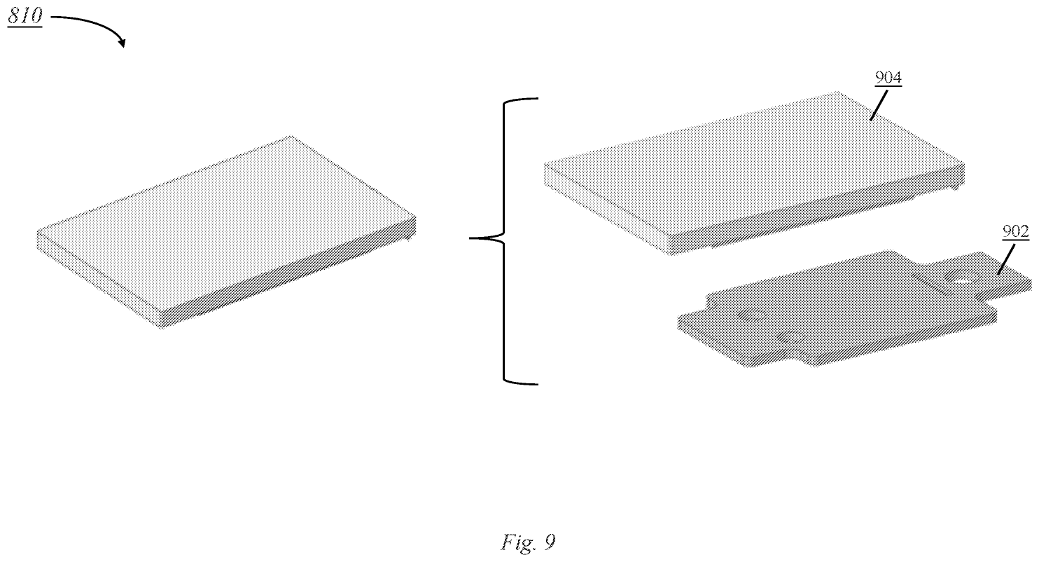

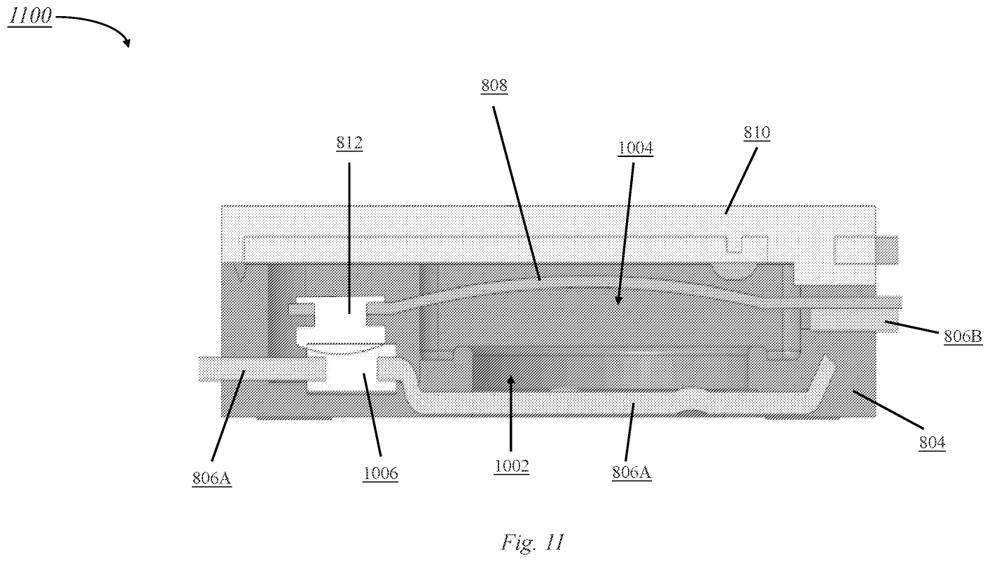

FIG. 8 is a representative exploded perspective drawing of a TCO device 800 usable as an SMD technology, according to exemplary embodiments. The TCO device 800 features a cover plate 810, an integrated bimetal and arm terminal 808 (also known herein as an “integrated terminal 808”), and a base portion 802. As before, the base portion 802 includes a base mold 804 and a base terminal 806. The integrated bimetal and arm terminal 808 simplify the structure of the TCO device 800, relative to the other embodiments shown and described herein. In an exemplary embodiment, the bimetal material of the integrated terminal 808 is 1) made from a low resistivity material to carry current during normal operation and 2) made from two metals having different thermal properties such that the terminal activates (e.g., deform into a convex state to “lift” the structure) during an abnormal condition, such as an overtemperature or overcurrent situation. Thus, the integrated terminal 808 is made using at least three metal materials, two metals for the activation operation, and a third, low resistivity metal for the conduction of current through the TCO device 800. The integrated terminal 808 is illustrated and described in more detail in FIG. 11, below. FIGS. 9-11 provide further detail on some of the components of the TCO device 800.

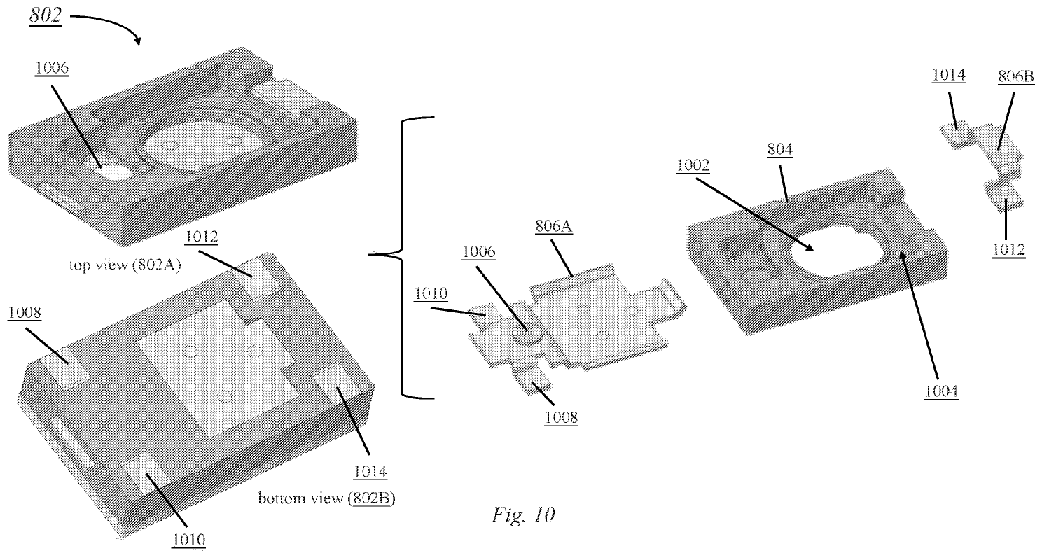

In an exemplary embodiment, the base portion 802 is structured for receipt of the integrated terminal 808, which is described in more detail in FIG. 10, below. The integrated terminal 808 includes a contact portion 812; similarly, the base terminal 806 of the base portion 802 includes a contact portion 814. The contact portions 812 and 814 ensure that a connection is made between the integrated terminal 808 and the base terminal 806, whether a PTC device is inserted into the base portion 802 or not. Once deformation of the integrated terminal 808 occurs, such as due to an overtemperature condition, the contact portions 812 and 814 separate.

FIG. 9 is a representative exploded perspective drawing of the cover plate 810 of the TCO device 800 of FIG. 8, according to exemplary embodiments. The cover plate 810 includes a cover portion 904, which may be plastic or other non-conductive material, and a plate portion 902, which may be formed of stainless steel, brass, or other material.

FIG. 10 is a representative exploded perspective drawing of the base portion 802 of the TCO device 800 of FIG. 8, according to exemplary embodiments. Both top views 802A and 802B of the base portion are shown. In contrast to the previous embodiments, the base terminal 806 consists of two separate parts, 806A and 806B. The base mold 804 includes a first receiving opening 1002 for seating an optional PTC device and a second receiving opening 1004 for receiving the integrated terminal 808. Because the bimetal disc and arm terminal are integrated together, the base portion 802 does not need three receiving openings, but instead has two. The base terminal portion 806A includes the contact portion 814 for connecting with a contact portion 812 of the integrated terminal 808 (FIG. 8).

Further, similar to the TCO device 100, the base portion 802 of the TCO device 800 includes four pads 1008, 1010, 1012, and 1014. The first portion of the base terminal 806A includes the pads 1010 and 1008 while the second portion of the base terminal 806B includes the pads 1014 and 1012. In an exemplary embodiment, the pads 1008, 1010, 1012, and 1014 facilitate attaching the TCO device 800 to a substrate such as a PCB using the surface mount reflow process.

The TCO device 800 thus integrates the arm terminal and bimetal device into a single structure, simplifying the device. Further, the base terminal 806 is separated into two distinct parts, in contrast to the base terminals of the TCO devices 100, 400, and 700.

FIG. 11 is a cross-sectional view drawing of the TCO device 800 of FIG. 8, according to exemplary embodiments. The base terminal 806A is enclosed in the device 800 by contact portion 1006 (FIG. 10) while the integrated terminal 808 is enclosed in the device by contact portion 812 (FIG. 8). First receiving opening 1002, for seating the optional PTC device, and second receiving opening 1004, for seating the integrated terminal 808 are also shown. In an exemplary embodiment, the integrated terminal 808 is welded to the base terminal 806 in the base mold 804.

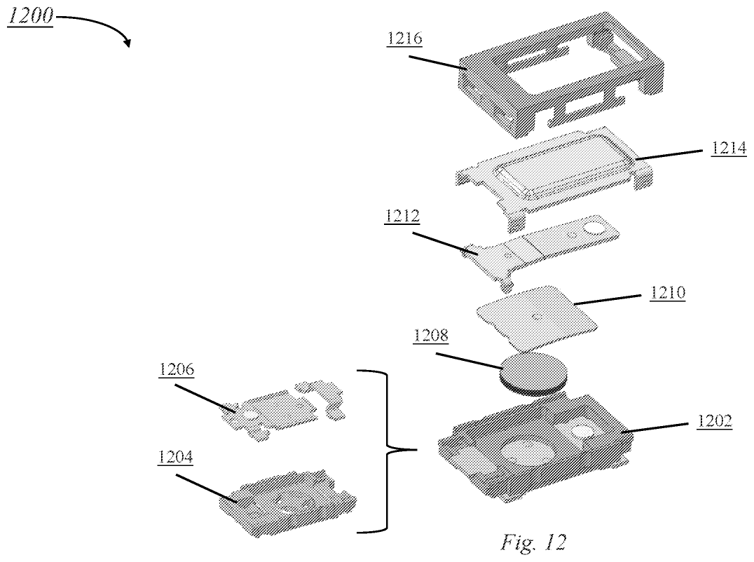

FIG. 12 is a representative exploded perspective drawing of a TCO device 1200 usable as an SMD technology, according to exemplary embodiments. The TCO device 1200 features a base portion 1202 including a base mold 1204 and a base terminal 1206, an optional PTC device 1208, a bimetal disc 1210, an arm terminal 1212, an upper plate 1214, and an overmold 1216. In exemplary embodiments, the base mold 1204 and the overmold 1216 are made using a liquid crystal polymer (LCP), the base terminal 1206 and arm terminal 1212 are made of copper and silver, and the upper plate 1214 is made of stainless steel. Like the other TCO devices disclosed herein, the TCO device 1200 provides overcurrent and overtemperature protection to other circuit components.

As used herein, an element or step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

While the present disclosure makes reference to certain embodiments, numerous modifications, alterations and changes to the described embodiments are possible without departing from the sphere and scope of the present disclosure, as defined in the appended claim(s). Accordingly, it is intended that the present disclosure not be limited to the described embodiments, but that it has the full scope defined by the language of the following claims, and equivalents thereof.

1. A thermal cut-off (TCO) device, comprising:
a base portion comprising a base mold and a base terminal, wherein the base terminal comprises first and second pads;
a bimetal disc seated in the base portion, the bimetal disc being disposed between the base terminal and the arm terminal; and
an arm terminal to electrically connect to the base terminal;
wherein the first and second pads are attachable to a substrate using a surface mount reflow process.

2. The TCO device of claim 1, the arm terminal further comprising third and fourth pads attachable to the substrate using the surface mount reflow process.

3. The TCO device of claim 1, the base portion further comprising:
a first receiving opening for seating the bimetal disc; and
a second receiving opening for seating the arm terminal,

4. The TCO device of claim 3, the base portion further comprising a third receiving opening for seating a positive temperature coefficient (PTC) device.

5. The TCO device of claim 1, wherein the base terminal and the arm terminal are electrically coupled together during normal operation of the TCO device.

6. The TCO device of claim 5, wherein the base terminal and the arm terminal are decoupled by the bimetal disc in response to an overcurrent or overtemperature event.

7. A thermal cut-off (TCO) device, comprising:
a base terminal comprising a first pair of pads;
an arm terminal comprising a second pair of pads;
a bimetal disc disposed between the base terminal and the arm terminal;
a cover plate having a first heat capacity and the base terminal comprising a second heat capacity, wherein the first heat capacity is lower than the second heat capacity.

8. The TCO device of claim 7, wherein the cover plate comprises holes to decrease a volume of the cover plate.

9. The TCO device of claim 7, wherein the cover plate comprises dimples.

10. The TCO device of claim 7, wherein the first pair of pads and the second pair of pads are attachable to a substrate using a surface mount reflow process.

11. A Thermal Cut-Off (TCO) device, comprising:
a cover plate;
a base portion, the base portion comprising a base mold and a base terminal, wherein the base terminal comprises pads suitable for a surface mount reflow process; and
an integrated terminal disposed between the cover plate and the base portion, the integrated terminal further comprising:
a first metal having a first coefficient of thermal expansion;
a second metal having a second coefficient of thermal expansion, wherein the first coefficient of thermal expansion is different from the second coefficient of thermal expansion; and
a third metal having a low resistivity suitable for conducting current.

12. The TCO of claim 11, the base terminal further comprising a first portion comprising first and second pads.

13. The TCO of claim 12, the base terminal further comprising a second portion comprising third and fourth pads.

14. The TCO of claim 11, the base mold further comprising:
a first receiving opening for seating the integrated terminal.

15. The TCO device of claim 11, wherein the integrated terminal and the base terminal are electrically connected during normal operation of the TCO device.

16. The TCO device of claim 15, wherein the integrated terminal and the base terminal are electrically decoupled during an overcurrent or overtemperature condition of the TCO device.

17. The TCO device of claim 14, further comprising a Positive Temperature Coefficient (PTC) device.

18. The TCO device of claim 17, the base mold further comprising:
a second receiving opening for seating the PTC device, wherein the first receiving portion is above the second receiving portion.

19. The TCO device of claim 11, the integrated terminal further including a first contact portion and the base terminal further including a second contact portion, wherein the first contact portion and the second contact portion join to establish a connection between the integrated terminal and the base terminal.

20. The TCO device of claim 11, the cover plate further comprising a cover portion and a plate portion.
